(19) United States
(12) Patent Application Publication
(10) Pub. No.: US 2025/0171237 A1
(43) Pub. Date: May 29, 2025

(54) FURNITURE TRANSPORTATION TOOL

(71) Applicant: Michael Somero, Marlbourgh, NH (US)

(72) Inventor: Michael Somero, Marlbourgh, NH (US)

(21) Appl. No.: 18/521,079

(22) Filed: Nov. 28, 2023

(51) Int. Cl. B65G 7/12

(52) U.S. Cl. CPC B65G 7/12; B65G 2201/0223

(57) ABSTRACT

Devices are provided for carrying a piece of furniture. An example device includes a set of arms that are transitionable, relative to each other, between first and second positions. The device also includes a first and second grip features and a locking mechanism configured to lock the set of arms in the second position. When the set of arms are in the first position, the first and second grip features are spaced apart by a first distance such that the first and second grip features are positionable around a portion of the piece of furniture. When the set of arms are in the second position, the first and second grip features are spaced apart by a second distance that is less than the first distance such that the first and second grip features, when the locking mechanism is locked, are configured to securely hold the piece of furniture therebetween.

### FIELD OF THE INVENTION

Example embodiments of the present invention generally relate to transportation tools and, more particularly to, tools for transportation of pieces of furniture.

### BACKGROUND

Many different types of pieces of furniture, such as mattresses, are difficult to transport. For example, mattresses are especially difficult to transport due to their cumbersome nature. Further, pieces of furniture such as mattresses are even more difficult to transport across terrain such as stairs, inclines, and tight spaces that are common in houses, apartment buildings, hotels, etc. in which furniture is often transported. Current solutions involve using multiple people to lift and carry furniture, often without any tools, and when tools are used, they often involve straps that are hard to steer and otherwise control. For example, many current strap systems create unwanted pressure and lack control, especially when transportation of the piece of furniture is taking place up or down a set of stairs.

Improvements in the foregoing are desired.

### BRIEF SUMMARY

Some example embodiments of the present invention include devices and methods for carrying a piece of furniture. The devices and methods described herein include a set of arms with grip features, and the set of arms is able to move from a first position to a second position to secure a piece of furniture, such as a mattress, therebetween. In some embodiments, a locking mechanism is included that locks the set of arms in the second position, and in some further embodiments, a connection portion and/or a handle is provided for a user to apply force onto the device such that the device (and therefore the piece of furniture) can be transported. This enables easy transportation of cumbersome pieces of furniture, such as mattresses, and further enables more control than a strap system, which is subject to unwanted force and torque, such as from swinging.

In some embodiments, a device for carrying a piece of furniture may include a set of arms that include a first arm and a second arm. The first and second arms may be transitionable, relative to each other, between a first position and a second position. The device may also include first and second grip features attached to the first arm and the second arm, respectively. Such grip features may be sized and shaped such that a gripping force is optimally distributed across a portion of the piece of furniture. In some embodiments, the device may include a locking mechanism configured to lock the set of arms when the set of arms are in the second position. Further, in some embodiments, the device may include a connecting portion that connects the first arm and the second arm.

When the set of arms are in the first position, the first grip feature may be spaced apart from the second grip feature by a first distance such that the first grip feature and the second grip feature are positionable around a portion of the piece of furniture. When the set of arms are in the second position, the first grip feature may be spaced apart from the second grip feature by a second distance that is less than the first distance such that the first furniture grip feature and the second furniture grip feature are configured to securely hold the piece of furniture therebetween.

The device may be used to transport the piece of furniture by enabling a user to exert force onto the device, which is gripping the piece of furniture, in a controlled manner. In embodiments in which a connecting portion is included, the connecting portion may itself serve as a handle for a user in some embodiments, while in other embodiments, the connecting portion may include a dedicated handle with which a user can exert force (e.g., a lifting and/or directional force for moving the piece of furniture).

In an example embodiment, a device for carrying a piece of furniture is provided. The device includes a set of arms that are transitionable, relative to each other, between a first position and a second position. The set of arms includes a first arm and a second arm, and each of the first arm and the second arm define a first end and a second end, the second end being opposite the first end. The device also includes a first grip feature attached to the first arm and positioned proximate the second end of the first arm, a second grip feature attached to the second arm and positioned proximate the second end of the second arm, and a locking mechanism configured to lock the set of arms when the set of arms are in the second position. When the set of arms are in the first position, the first grip feature is spaced apart from the second grip feature by a first distance such that the first grip feature and the second grip feature are positionable around a portion of the piece of furniture. When the set of arms are in the second position, the first grip feature is spaced apart from the second grip feature by a second distance that is less than the first distance such that the first grip feature and the second grip feature, when the locking mechanism is locked, are configured to securely hold the piece of furniture therebetween.

In some embodiments, the device may further include a connecting portion between the set of arms.

In some embodiments, the locking mechanism may extend from the first arm to the second arm so as to define a portion that comprises the connecting portion.

In some embodiments, the connecting portion between the set of arms may form a handle.

In some embodiments, the handle may be rigid.

In some embodiments, the locking mechanism may be removable from the device.

In some embodiments, the first grip feature may include a first disc, and the second grip feature may include a second disc.

In some embodiments, a first diameter of the first disc may be greater than 5 inches, and a second diameter of the second disc may be greater than 5 inches.

In some embodiments, the locking mechanism may include a bar extending from the first arm across to the second arm of the set of arms, and the locking mechanism may further include a clamping mechanism or a screw mechanism that slides the first arm and the second arm along the bar in an inward direction such that the set of arms transition from the first position to the second position and then lock, via the clamping mechanism or the screw mechanism being tightened, in the second position.

In some embodiments, the piece of furniture may be a mattress.

In some embodiments, the locking mechanism may be slidable along the set of arms.

In some embodiments, the device may be comprised of aluminum.

In some embodiments, the device may be comprised of plastic.

In some embodiments, the set of arms may be parallel when in the first position.

In some embodiments, the set of arms may be parallel when in the second position.

In another example embodiment, a method of manufacturing a device is provided.

The method includes providing a set of arms that are transitionable, relative to each other, between a first position and a second position. The set of arms includes a first arm and a second arm, and each of the first arm and the second arm define a first end and a second end, the second end being opposite the first end. The method also includes attaching a first grip feature to the first arm such that it is positioned proximate the second end of the first arm, attaching a second grip feature to the second arm such that it is positioned proximate the second end of the second arm, and providing a locking mechanism configured to lock the set of arms when the set of arms are in the second position. When the set of arms are in the first position, the first grip feature is spaced apart from the second grip feature by a first distance such that the first grip feature and the second grip feature are positionable around a portion of the piece of furniture. When the set of arms are in the second position, the first grip feature is spaced apart from the second grip feature by a second distance that is less than the first distance such that the first grip feature and the second grip feature, when the locking mechanism is locked, are configured to securely hold the piece of furniture therebetween.

In some embodiments, the method may further include providing a connecting portion between the set of arms.

In some embodiments, the connecting portion between the set of arms may form a handle.

In some embodiments, the piece of furniture may be a mattress.

In another example embodiment, a device for carrying a piece of furniture is provided. The device includes a set of arms that are transitionable, relative to each other, between a first position and a second position. The set of arms includes a first arm and a second arm, and each of the first arm and the second arm define a first end and a second end, the second end being opposite the first end. The device also includes a first grip feature attached to the first arm and positioned proximate the second end of the first arm, a second grip feature attached to the second arm and positioned proximate the second end of the second arm, and a handle positioned proximate the set of arms. When the set of arms are in the first position, the first grip feature is spaced apart from the second grip feature by a first distance such that the first grip feature and the second grip feature are positionable around a portion of the piece of furniture. When the set of arms are in the second position, the first grip feature is spaced apart from the second grip feature by a second distance that is less than the first distance such that the first grip feature and the second grip feature are configured to securely hold the piece of furniture therebetween.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a perspective view of an example device disposed around a mattress with a user holding the device, the device being locked in a second position, in accordance with some embodiments discussed herein;

FIG. 2 shows a top perspective view of the device of FIG. 1 in a first position, in accordance with some embodiments discussed herein;

FIG. 3 shows a top perspective view of the device of FIGS. 1-2 in the second position, in accordance with some embodiments discussed herein;

FIG. 4 shows a top, front perspective view of the device of FIGS. 1-3 disposed around the mattress of FIG. 1, in accordance with some embodiments discussed herein;

FIG. 5 shows a side perspective view of the device of FIGS. 1-4 disposed around the mattress of FIGS. 1 and 4, in accordance with some embodiments discussed herein;

FIG. 6 shows a perspective view of the device of FIGS. 1-5 disposed around the mattress of FIGS. 1 and 4-5, the device having a handle, in accordance with some embodiments discussed herein;

FIG. 7 illustrates a first user and a second user carrying a mattress using an example first device and an example second device, in accordance with some embodiments discussed herein;

FIG. 8 illustrates a user dragging a mattress on a sheet using an example device, in accordance with some embodiments discussed herein;

FIG. 9 illustrates a user dragging a mattress on a set of rollers using an example device, in accordance with some embodiments discussed herein; and

FIG. 10 is a flowchart showing an example method of manufacturing a device, in accordance with some embodiments discussed herein.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

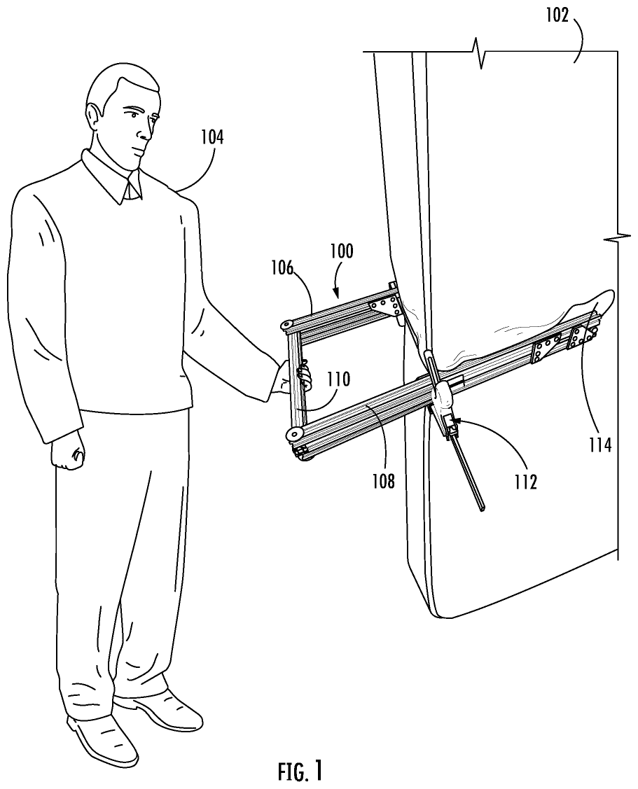

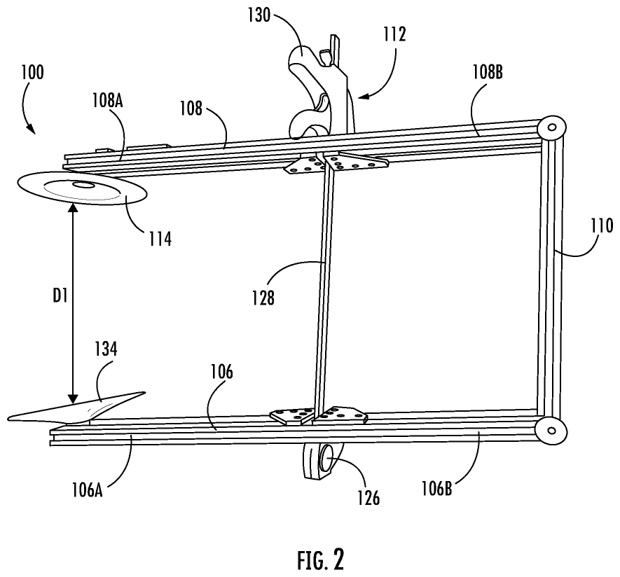

FIG. 1 shows a mattress 102 being carried by a user 104 using a device 100. The device 100 includes a set of arms including a first arm 106 and a second arm 108 connected by a connecting portion 110. The user 104 is providing an upward force by lifting the connecting portion 110 of the device. The set of arms are transitionable, relative to each other, between a first position and a second position. With further reference to FIG. 2, the first arm 106 defines a first end 106A and a second end 106B, and the second arm 108 defines a first end 108A and a second end 108B. The second end 106B is opposite the first end 106A, and the second end 108B is opposite the first end 108A. Further, each of the set of arms includes a grip feature. For example, the second arm 108 includes a second grip feature 114 positioned proximate the second end 108B of the second arm 108. The first arm 106 includes a first grip feature 134 positioned proximate the second end 106B of the first arm 106. The device 100 also includes a locking mechanism 112 which is configured to lock the set of arms in a second position after the set of arms have been positioned around the mattress 102. As described herein, the locking mechanism 112 may be a screw mechanism, a clamping mechanism, or any other type of mechanism.

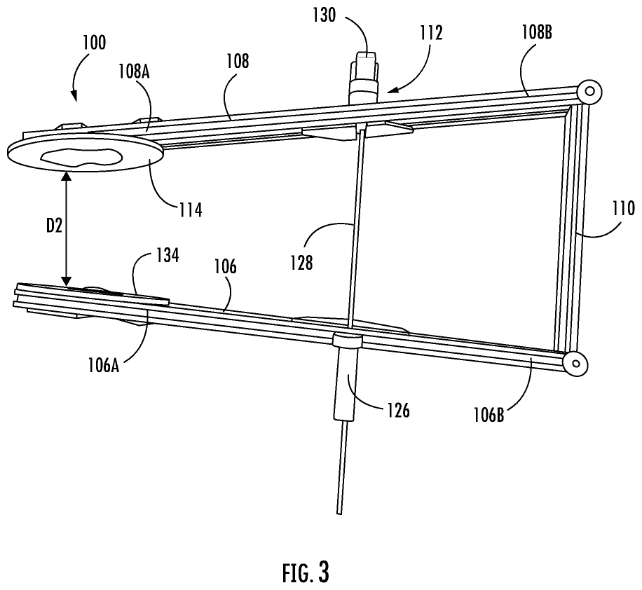

FIG. 2 shows the device 100 in a first position in which the set of arms are positioned at a first distance D1 from one another. That is, when the set of arms is in the first position, the first grip feature 134 is spaced apart from the second grip feature 114 by the first distance D1 such that the first grip feature 134 and the second grip feature 114 are positionable around a portion of a piece of furniture. In some embodiments, the first grip feature 134 may include a first disc, and the second grip feature 114 may include a second disc, as shown in FIGS. 2-3. In some embodiments, for example, a first diameter of the first disc may be greater than 5 inches, and a second diameter of the second disc may be greater than 5 inches. Such a diameter size and circular shape of the discs may enable a gripping force to be spread across the piece of furniture (as, in some cases, a more pointed or focused force application may be damaging to the piece of furniture). It should be appreciated, however, that any other shaped and/or sized grip features are also contemplated within the scope of this disclosure.

Still referring to FIGS. 2-3, the locking mechanism 112 may include a bar 128 extending from the first arm 106 across to the second arm 108 of the set of arms, and the locking mechanism 112 may further include a mechanism, such as a clamping mechanism or a screw mechanism, that moves the first arm 106 and the second arm 108, e.g., along the bar 128, in an inward direction such that the set of arms transition from the first position to the second position and then lock, via the clamping mechanism or the screw mechanism being tightened, in the second position. In some embodiments, the locking mechanism 112 may be permanently installed onto the set of arms. In other embodiments, the locking mechanism 112 may be removable from the device 100. Further, in some embodiments, the locking mechanism 112 may be slidable along the set of arms.

It should be appreciated that, in some embodiments, the device 100 may not include a locking mechanism at all. For example, the connecting portion 110 may instead be expandable such that, when a user applies force onto the device 100 by lifting the connecting portion 110, the second end 106B of the first arm 106 and the second end 106B of the second arm 108 move farther apart and the first end 106A of the first arm 106 and the first end 108A of the second arm 108 move closer together due to the expansion of the connection portion 110. Such movement would then cause the piece of furniture (e.g., the mattress 102) to be gripped between the grip features without need for a locking mechanism. The expansion of the connecting portion 110 may be achieved using an expandable material, a biasing member, or any other configuration. Other configurations are also contemplated within the scope of this disclosure to eliminate or work with a locking mechanism.

FIG. 3 shows the device 100 in the second position in which the set of arms are positioned at a second distance D2 from one another. That is, when the set of arms are in the second position, the first grip feature 134 is spaced apart from the second grip feature 114 by a second distance D2 that is less than the first distance D1 such that the first grip feature 134 and the second grip feature 114 are configured to securely hold a piece of furniture therebetween. In some cases, as noted above, locking of the locking mechanism while the set of arms are in the second position (with the piece of furniture therebetween) may enable securement of the piece of furniture for easy transportation.

It should be appreciated that the first distance D1 and the second distance D2 may be any value. For example, in some embodiments, the first distance D1 may be approximately 16 inches and the second distance D2 may be approximately 8 inches. In other embodiments, however, other values for the first distance D1 and the second distance D2 are possible. In this regard, the second distance may be any value and variable so as to enable securement of differently sized/shaped pieces of furniture.

Further, in some embodiments, the device 100 and the locking mechanism 112 may be configured such that the set of arms are parallel when in the first position, and additionally or alternatively, in some embodiments, the device 100 and the locking mechanism 112 may be configured such that the set of arms are parallel when in the second position. Further, in some other embodiments, the device 100 and the locking mechanism 112 may be configured such that the set of arms are not parallel in either of the first position or the second position.

It should be appreciated that the device 100 may be made of any material. For example, some or all of the components of the device 100 may be comprised of aluminum in some embodiments, while in some other embodiments, some or all of the components of the device 100 may be comprised of plastic. Other materials are also contemplated within the scope of this disclosure.

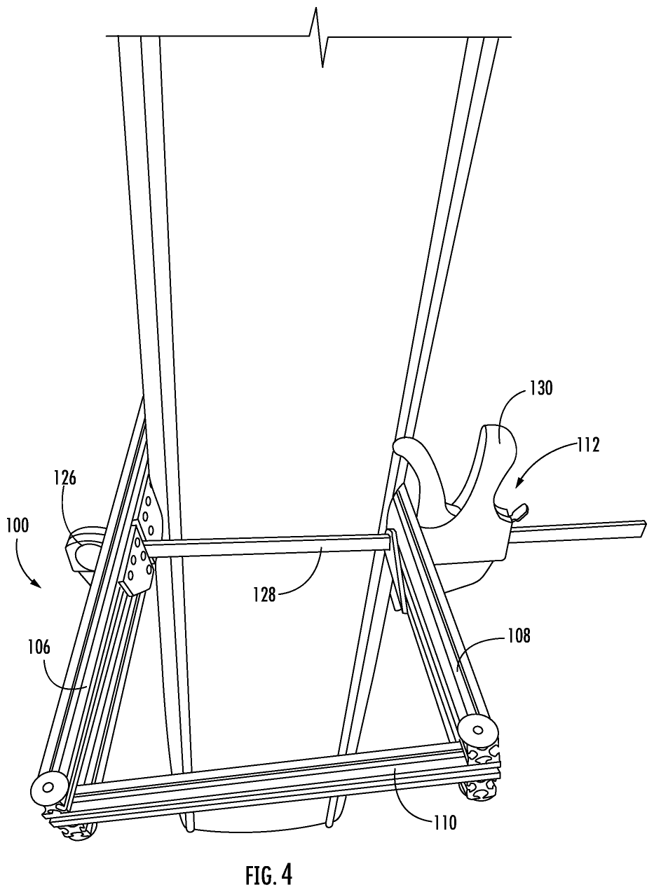

FIG. 4 illustrates a front view of the device 100 having been clamped onto the mattress 102 via the locking mechanism 112. The locking mechanism 112 in FIG. 4 is a clamping mechanism having a handle 130, a component 126, and the bar 128 extending therebetween. The locking mechanism 112 is configured such that squeezing the handle 130 causes the handle 130 to push the second arm 108 along the bar 128 toward the first arm 106 (and/or the first arm 106 along the bar 128 toward the second arm 108). Because the component 126 is larger than a hole in the first arm 106 containing the bar 128, squeezing of the handle 130 causes the first end 106A of the first arm 106 and the first end 108A of the second arm 108 to move closer to each other (e.g., see transition from FIG. 2 to FIG. 3). Components within the handle 130 (e.g., a biasing member, an elastic material, etc.) may then prevent the handle 130 from retracting in the opposite direction unless or until the handle 130 is squeezed again.

In some embodiments, the bar 128 of the locking mechanism 112 may also be the connecting portion 110, but in other embodiments, such as that shown in FIGS. 2-3, the bar 128 of the locking mechanism 112 may be separate from the connecting portion 110. Further, the connecting portion 110 may not be included at all and a user may be able to pick up the device 100 using the bar 128, the set of arms themselves, or another handle (or handles) disposed on one or both of the set of arms.

It should be appreciated that, although the locking mechanism 112 that is shown in FIGS. 1-6 is a clamping mechanism comprised of the handle 130, the bar 128, and the component 126, the locking mechanism 112 may be any other mechanism with any other configuration of components, including another type of clamping mechanism. For example, the locking mechanism 112 may be a screw mechanism, a spring mechanism, a hydraulic mechanism, or any other type of mechanism that allows the first arm 106 and the second arm 108 to lock in place at desired distance(s) from each other.

Referring still to FIG. 4, the mattress 102 has been positioned between the first arm 106 and the second arm 108 such that the bar 128 of the locking mechanism 112 rests adjacent the mattress 102. However, it should be appreciated that, in other embodiments, the bar 128 may not rest adjacent to the mattress 102, or the bar 128 may not be included at all. The locking mechanism 112 may be adjustable to a user's preferred tightness around the mattress 102. For example, the handle 130 in FIG. 4 is configured such that, when a user squeezes it, the handle 130 slides and locks to a position that is closer to (or farther from) the component 126. The adjustability may allow a user to be able to achieve a tightest fit around different mattresses (e.g., mattress 102) without damaging the mattresses.

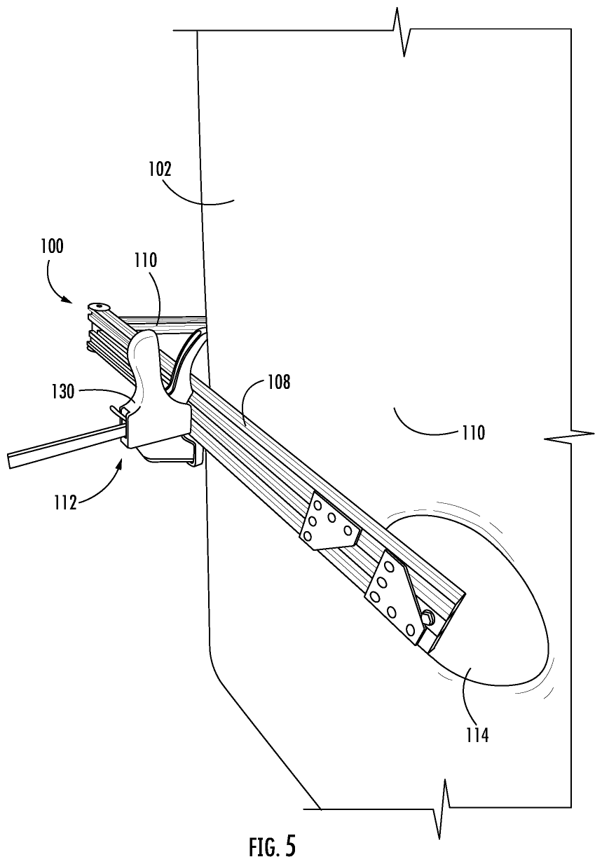

FIG. 5 shows a side, perspective view of the second grip feature 114 when the device 100 has been positioned around the mattress 102 and when the set of arms have been transitioned and locked in the second position. As shown, the second grip feature 114 (and the first grip feature 134, which is not shown) is a disc that has a larger surface area than an end portion of the second arm 108. The larger surface area spreads out a gripping force applied by the set of arms having been transitioned from the first position to the second position. The force being spread out across the surface areas of the first grip feature 134 and the second grip feature 114 makes sure an optimal grip of the mattress 102 is achieved to enable transportation without damaging the mattress 102. It should be appreciated that the first grip feature 134 and the second grip feature 114 may be any other shape.

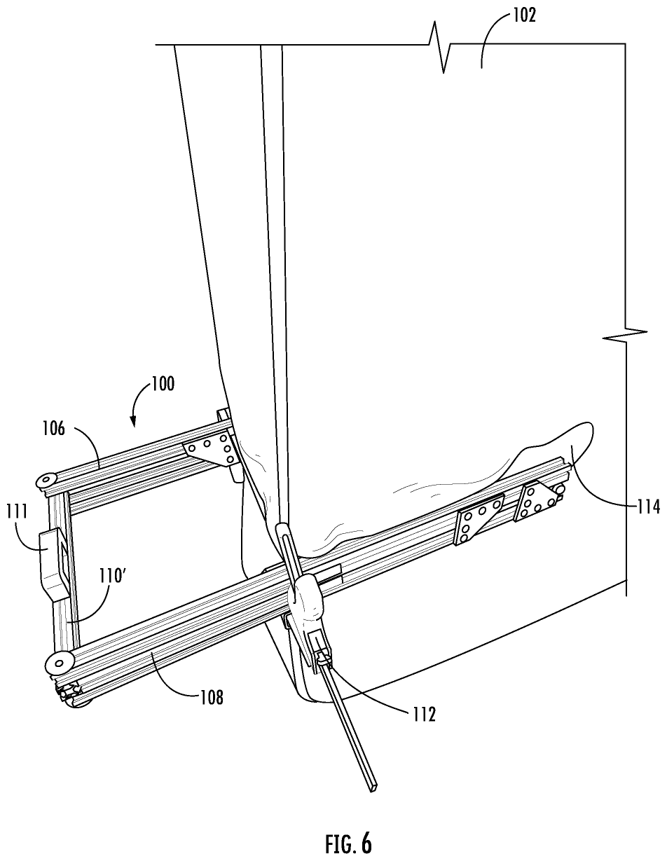

While the connecting portion 110 in FIGS. 1-5 can be used to pick up the mattress 102, FIG. 6 shows the device 100 having a connecting portion 110′ between the set of arms that also includes a handle 111. In some embodiments, the handle 111 may be rigid, while in other embodiments, the handle 111 may not be rigid. For example, the handle 111 may include one or more straps (e.g., to fit around the user to aid in transportation of the mattress/distribution of the weight, etc.) or any other component. The handle 111 may provide more comfort to a user when transporting the mattress 102 using the device 100.

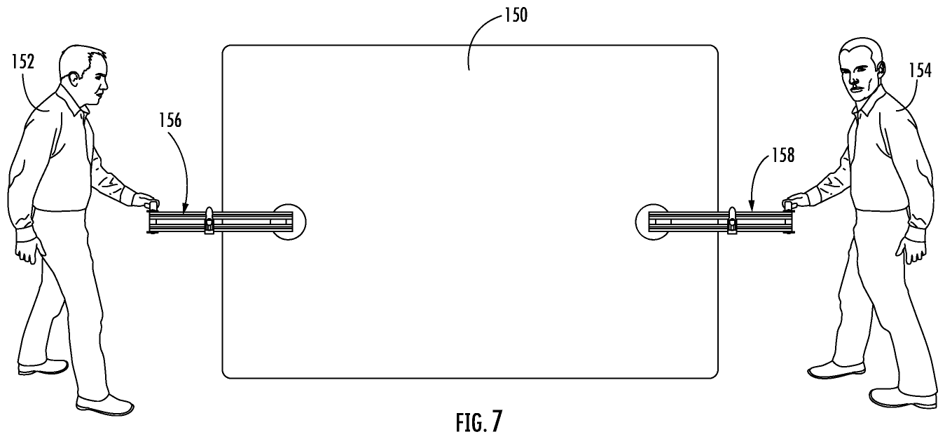

FIG. 7 shows a first user 152 and a second user 154 carrying a mattress 150 using a first device 156 and a second device 158, respectively. The first device 156 and/or the second device 158 may be similar to the device 100 shown and described with respect to FIG. 1-6, or the first device 156 and/or the second device 158 may be configured differently, such as with different types of locking mechanisms. As shown, the first device 156 and the second device 158 are positioned on different sides of the mattress 150 such that, when the first user 152 and the second user 154 exert upward forces on the first device 156 and the second device 158, respectively, the mattress 150 is lifted off of the ground and can be carried. Notably, the use of the first device 156 and the second device 158 in this manner allows controlled movement on any type of terrain, including up or down stairs.

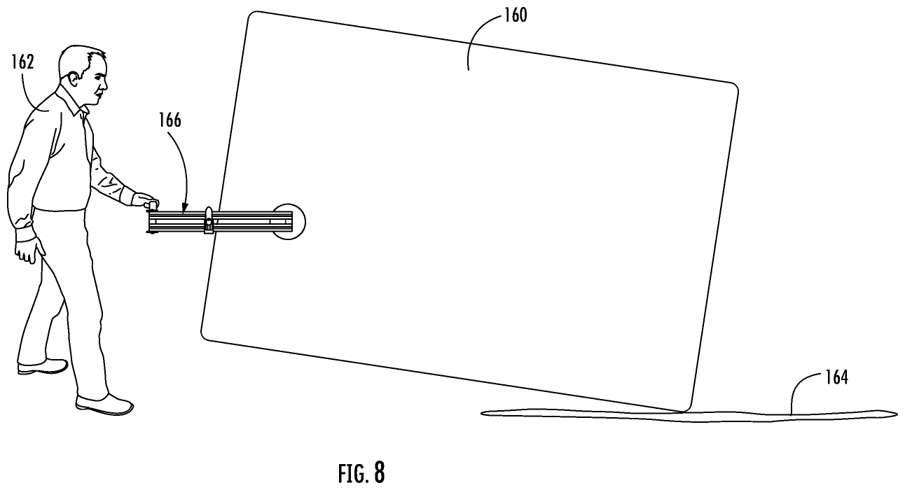

FIG. 8 shows a user 162 carrying a mattress 160 using a device 166. Instead of having another user on the other side of the mattress 160 as in FIG. 7, in FIG. 8, the user 162 is dragging the mattress 160 along a terrain such as a floor of a house, stairs, or a sidewalk. In the embodiment shown in FIG. 8, the mattress 160 is being dragged on a sheet of material 164 to lessen the friction and/or to protect the mattress 160 from the terrain over which it is being carried. It should be appreciated that the sheet of material 164 is not necessary and that the mattress 160 may be draggable directly on the terrain. Further, any other barrier object may be used instead of the sheet of material 164.

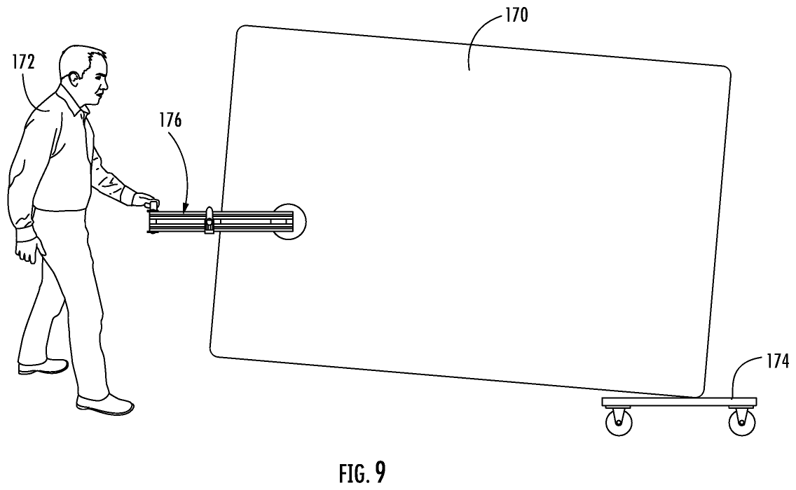

FIG. 9 shows a user 172 carrying a mattress 170 using a device 176. Similar to the embodiment shown in FIG. 8, in FIG. 9, the user 172 is dragging the mattress 170 along a terrain such as a floor of a house, stairs, or a sidewalk. In the embodiment shown in FIG. 9, however, the mattress 170 is being dragged using a platform with a set of rollers 174 to lessen the friction and/or to protect the mattress 170 from the terrain over which it is being carried. It should be appreciated that the platform with the set of rollers 174 is not necessary, and that the mattress 170 may be draggable directly on the terrain. Further, any other transportation aid may be used instead of the platform with the set of rollers 174.

### Example Flowchart(s)

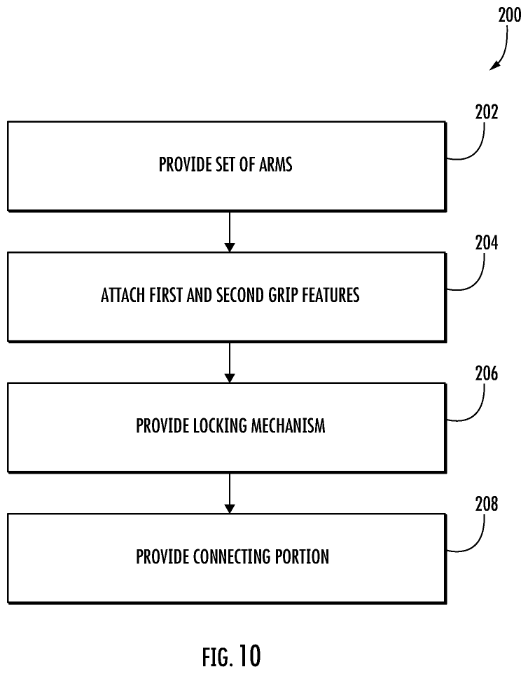

Embodiments of the present disclosure provide various methods for manufacturing a device, such as described herein. Various examples of the operations performed in accordance with some embodiments of the present disclosure will now be provided with reference to FIG. 10.

FIG. 10 illustrates a flowchart according to an example method 200 of manufacturing a device according to an example embodiment. The method 200 may include providing a set of arms at operation 202. For example, the set of arms may be transitionable, relative to each other, between a first position and a second position, and the set of arms may include a first arm and a second arm. Each of the first arm and the second arm may define a first end and a second end, the second end being opposite the first end.

At operation 204, the method 200 may include attaching a first grip feature to the first arm such that it is positioned proximate the second end of the first arm and attaching a second grip feature to the second arm such that it is positioned proximate the second end of the second arm. For example, the first grip feature and the second grip feature may be disc shaped.

At operation 206, the method 200 may include providing a locking mechanism configured to lock the set of arms when the set of arms are in the second position. For example, the device may be configured such that, when the set of arms is in the first position, the first grip feature is spaced apart from the second grip feature by a first distance such that the first grip feature and the second grip feature are positionable around a portion of the piece of furniture. Further, the device may be configured such that, when the set of arms is in the second position, the first grip feature is spaced apart from the second grip feature by a second distance that is less than the first distance such that the first grip feature and the second grip feature, when the locking mechanism is locked, are configured to securely hold the piece of furniture therebetween. It should be appreciated, however, that the locking mechanism may be optional.

At operation 208, the method 200 may include providing a connecting portion between the set of arms. For example, in some embodiments, the connecting portion may enable a user to exert a force on the device by picking it up, and in some further embodiments, the connecting portion may include a handle. It should be appreciated, however, that the connecting portion may be optional.

Additional operations are also contemplated, such as providing a handle, such as described herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

### CONCLUSION

Many modifications and other embodiments of the inventions set forth herein may come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A device for carrying a piece of furniture, the device comprising:
a set of arms that are transitionable, relative to each other, between a first position and a second position, wherein the set of arms comprises a first arm and a second arm, wherein each of the first arm and the second arm define a first end and a second end, the second end being opposite the first end;
a first grip feature attached to the first arm and positioned proximate the second end of the first arm;
a second grip feature attached to the second arm and positioned proximate the second end of the second arm; and
a locking mechanism configured to lock the set of arms when the set of arms are in the second position,
wherein, when the set of arms are in the first position, the first grip feature is spaced apart from the second grip feature by a first distance such that the first grip feature and the second grip feature are positionable around a portion of the piece of furniture,
wherein, when the set of arms are in the second position, the first grip feature is spaced apart from the second grip feature by a second distance that is less than the first distance such that the first grip feature and the second grip feature, when the locking mechanism is locked, are configured to securely hold the piece of furniture therebetween.

2. The device of claim 1, wherein the device further comprises a connecting portion between the set of arms.

3. The device of claim 2, wherein the locking mechanism extends from the first arm to the second arm so as to define a portion that comprises the connecting portion.

4. The device of claim 2, wherein the connecting portion between the set of arms forms a handle.

5. The device of claim 4, wherein the handle is rigid.

6. The device of claim 1, wherein the locking mechanism is removable from the device.

7. The device of claim 1, wherein the first grip feature includes a first disc, and wherein the second grip feature includes a second disc.

8. The device of claim 7, wherein a first diameter of the first disc is greater than 5 inches, and wherein a second diameter of the second disc is greater than 5 inches.

9. The device of claim 1, wherein the locking mechanism includes a bar extending from the first arm across to the second arm of the set of arms, and wherein the locking mechanism further comprises a clamping mechanism or a screw mechanism that slides the first arm and the second arm along the bar in an inward direction such that the set of arms transition from the first position to the second position and then lock, via the clamping mechanism or the screw mechanism being tightened, in the second position.

10. The device of claim 1, wherein the piece of furniture is a mattress.

11. The device of claim 1, wherein the locking mechanism is slidable along the set of arms.

12. The device of claim 1, wherein the device is comprised of aluminum.

13. The device of claim 1, wherein the device is comprised of plastic.

14. The device of claim 1, wherein the set of arms are parallel when in the first position.

15. The device of claim 1, wherein the set of arms are parallel when in the second position.

16. A method of manufacturing a device, the method comprising:
providing a set of arms that are transitionable, relative to each other, between a first position and a second position, wherein the set of arms comprises a first arm and a second arm, wherein each of the first arm and the second arm define a first end and a second end, the second end being opposite the first end;
attaching a first grip feature to the first arm such that it is positioned proximate the second end of the first arm;
attaching a second grip feature to the second arm such that it is positioned proximate the second end of the second arm; and
providing a locking mechanism configured to lock the set of arms when the set of arms are in the second position,
wherein, when the set of arms are in the first position, the first grip feature is spaced apart from the second grip feature by a first distance such that the first grip feature and the second grip feature are positionable around a portion of the piece of furniture,
wherein, when the set of arms are in the second position, the first grip feature is spaced apart from the second grip feature by a second distance that is less than the first distance such that the first grip feature and the second grip feature, when the locking mechanism is locked, are configured to securely hold the piece of furniture therebetween.

17. The method of claim 16, further comprising providing a connecting portion between the set of arms.

18. The method of claim 17, wherein the connecting portion between the set of arms forms a handle.

19. The method of claim 16, wherein the piece of furniture is a mattress.

20. A device for carrying a piece of furniture, the device comprising:
a set of arms that are transitionable, relative to each other, between a first position and a second position, wherein the set of arms comprises a first arm and a second arm, wherein each of the first arm and the second arm define a first end and a second end, the second end being opposite the first end;
a first grip feature attached to the first arm and positioned proximate the second end of the first arm;
a second grip feature attached to the second arm and positioned proximate the second end of the second arm; and
a handle positioned proximate the set of arms,
wherein, when the set of arms are in the first position, the first grip feature is spaced apart from the second grip feature by a first distance such that the first grip feature and the second grip feature are positionable around a portion of the piece of furniture,
wherein, when the set of arms are in the second position, the first grip feature is spaced apart from the second grip feature by a second distance that is less than the first distance such that the first grip feature and the second grip feature are configured to securely hold the piece of furniture therebetween.
